(19) United States
(12) Patent Application Publication
(10) Pub. No.: US 2014/0026157 A1
(43) Pub. Date: Jan. 23, 2014

(54) FACE RECOGNITION CONTROL AND SOCIAL NETWORKING

(71) Applicants: Tao Wang, Beijing (CN); Wenlong Li, Beijing (CN); Qiang Li, Beijing (CN); Peng Wang, Beijing (CN); Jiqiang Song, Beijing (CN); Jianguo Li, Beijing (CN); Yangzhou Du, Beijing (CN); Yimin Zhang, Beijing (CN)

(72) Inventors: Tao Wang, Beijing (CN); Wenlong Li, Beijing (CN); Qiang Li, Beijing (CN); Peng Wang, Beijing (CN); Jiqiang Song, Beijing (CN); Jianguo Li, Beijing (CN); Yangzhou Du, Beijing (CN); Yimin Zhang, Beijing (CN)

(21) Appl. No.: 13/996,499

(22) PCT Filed: Apr. 11, 2011
(86) PCT No.: PCT/CN2011/072589

§ 371 Date: Aug. 29, 2013

(51) Int. Cl. H04N 21/4415; H04N 21/442

(52) U.S. Cl. CPC H04N 21/4415; H04N 21/44218
USPC 725/12

(57) ABSTRACT

Methods, apparatuses, and articles associated with face recognition login, social network and video chat are disclosed herein. In various embodiments, an apparatus may include a networking interface, and a face recognition based controller configured to determine whether a user is watching a television, based on image frames of a video signal generated by a camera. The controller may be further configured to transmit a login request, via the network interface, to a server associated with a social network, on determination that the user is watching the television, to log the user into the social network, and enabling video chat. Other embodiments may be disclosed and/or claimed.

### TECHNICAL FIELD

Embodiments of the present disclosure relate to the field of data processing, in particular, to methods, apparatuses and articles associated with face recognition based control, and social networking.

### BACKGROUND

Unless otherwise indicated herein, the materials described in this section are not prior art to the claims in this application and are not admitted to be prior art by inclusion in this section.

With the fast growth of smart TV, smart phones, and tablets, there is an urgent desire to create innovative features/usage models to provide customers with better personalized service, social network and added value service (AVS) based on higher computing power, wider bandwidth and richer content. For personalized service and social network on these embedded platforms, one of the most important problems is user login, that is, determining whether the user is a legal user and who the user is.

For user login, traditional methods include input passwords, magnetic or smart cards, user fingerprints, iris recognition, and voice recognition. But for most smart TV/phone/tablet applications, the traditional methods are generally not convenient, nor natural. Further, the traditional method may be insecure due to the possibility of theft or forgery. For example, an unauthorized user may gain access to an active session during the authorized users' temporary absence from the logged in device.

### BRIEF DESCRIPTION OF THE DRAWING

Embodiments of the present disclosure will be presented by way of example embodiments, but not limitations, illustrated in the accompanying drawings in which like references denote similar elements, and in which:

FIG. 1 illustrates an overview of a face recognition based control and social network arrangement, in accordance with various embodiments of the present disclosure;

FIG. 2 illustrates a method suitable for use by the face recognition based controller of FIG. 1, in accordance with various embodiments of the present disclosure;

FIG. 3 illustrates a number of instances of a user interface of the face recognition based control and social network arrangement of FIG. 1 in further detail, in accordance with various embodiments of the present disclosure;

FIG. 4 illustrates a method suitable for use by the login function and social networking function of FIG. 1, in accordance with various embodiments of the present disclosure;

FIG. 5 illustrates an example computer system suitable for use to practice the set-top box or social network server of FIG. 1, in accordance with embodiments of the present disclosure;

FIG. 6 illustrates an article of manufacture having programming instructions configured to cause an apparatus to practice one of the methods of FIGS. 2 and 4, in accordance with embodiments of the present disclosure; and

FIG. 7 illustrates an overview of another face recognition based control and social network arrangement, in accordance with various embodiments of the present disclosure.

### DETAILED DESCRIPTION

Methods, apparatuses, and articles associated with face recognition login, social network and video chat are disclosed herein. In various embodiments, an apparatus may include a networking interface, and a face recognition based controller (FRBC) configured to determine whether a user is watching a television based on image frames of a video signal generated by a camera. The controller may be further configured to transmit a log in request, via the network interface, to a server associated with a social network, on determination that the user is watching the television, to log the user into the social network. Thereafter, video chat with other users of the social network may be enabled.

In various embodiments, the FRBC may be further configured to determine the social network, a user identifier of the user in the social network, and a user password for the user identifier, by matching the one or more image frames against a repository of user pictures. On determination that the user is watching the television, the FRBC may transmit the user identifier of the user and the user password, in association with the login request, to the server associated with the social network. The repository may be locally or remotely located.

In various embodiments, the FRBC may be further configured to determine the social network, and a user identifier of the user in the social network, by matching the one or more image frames against a locally or remotely disposed repository of user pictures. On determination that the user is watching the television, the FRBC may transmit the user identifier of the user and one or more of the one or more image frames, in association with the login request, to the server associated with the social network.

In various embodiments, the FRBC may be further configured to transmit the one or more image frames, in association with the login request, to the server associated with the social network, on determination that the user is watching the television.

In various embodiments, the FRBC may be further configured to identify the user, using the one or more image frames, and to customize a user interface of the television, based on a result of the identification. The FRBC may be further configured to transition the television between a power saving mode and a television mode, having different levels of power consumption, based on the determination on whether a user is watching the television.

In various embodiments, the apparatus may include the repository of user pictures. The apparatus may be a set-top box. The apparatus may include the camera and/or the television.

In various embodiments, a method may include receiving one or more image frames, by a server associated with a social network, from an apparatus remotely disposed from the server. The apparatus may be associated with or has a television and/or a camera. The method may further include determining whether to allow a user to log into the social network, based at least in part on the one or more image frames.

In various embodiments, receiving may further include receiving, by the server, a user identifier of the user. Determining may include matching the one or more image frames against social media of the social network contributed by the user. In other embodiments, determining may include identifying the user by matching the one or more image frames against selected social media of the social network, without regard to contributor. In these embodiments, receiving may further include receiving, by the server, a fingerprint of the apparatus. Determining may then be further based on the received fingerprint of the apparatus. In other embodiments, receiving may further include receiving, by the server, a response to a challenge posed by the server, from the apparatus. Determining may then be further based on the received response to the challenge.

In various embodiments, the method may further include transmitting, by the server, a video chat launch icon for display on the television, and selection by the user, after logging the user into the social network. Additionally, the method may include transmitting, by the server, one or more status indicators of one or more other users associated with the user in the social network, for display on the television to indicate to the user, availability of the one or more other users for video chat with the user, after logging the user into the social network. Further, the method may include transmitting and receiving, to and from the television, by the server, audio and video signals associated with a video chat between the user and another user of the social network, after the user entering into a video chat with another user of the social network.

Various aspects of the illustrative embodiments will now be further described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. A feature described in a parenthetical format denotes the feature as an optional feature, e.g., “an instance of (partitions of) an application service,” denotes the application service may or may not be “partitioned.”

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

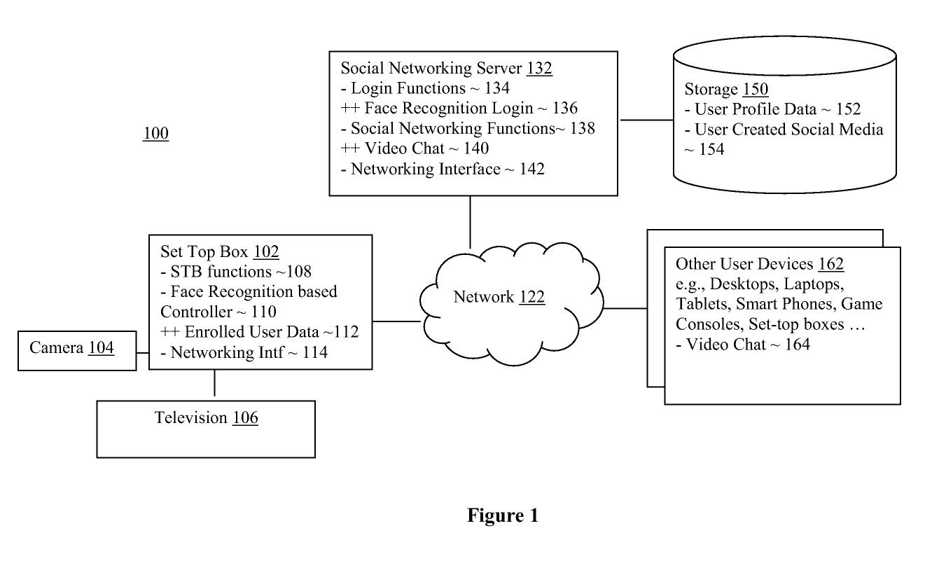

FIG. 1 illustrates an overview of a face recognition based control and social network arrangement, in accordance with various embodiments of the present disclosure. As illustrated, for the embodiments, face recognition based control and social network arrangement 100 may include set-top box 102, social networking server 132, and other user devices 162, coupled to each other via network 122, as shown. Set-top box 102 may be associated with one or more users of a social network associated with social networking server 132, whereas other user devices 162 may be associated with other users of the social network.

For the embodiments, set-top box 102 may be coupled to camera 104 and television 106, as shown. Set-top box 102 may be configured with conventional set-top box (STB) functions 108 for providing television programming to television 106. Additionally, set-top box 102 may be configured with face recognition based controller (FRBC) 110 and networking interface 114. As will be described in more details below, FRBC 110 may be configured to determine whether a user is watching television 106 based on image frames of a video signal generated by camera 104. Additionally, FRBC 110 may be further configured to transmit a log in request, via network interface 114, to social networking server 132, on determination that the user is watching television 106, to log the user into the social network. Thereafter, video chat with other users of the social network may be enabled.

In various embodiments, set-top box 102 may further include enrolled user data 112 of the associated users. Enrolled user data 112 may include reference pictures of the associated users for identification. Additionally, enrolled user data 112 may include user identifiers of the associated users for the social network, and their corresponding passwords.

Camera 104 and television 106, except for their use in conjunction with set-top box 102 and other aspects of arrangement 100, may be any one of a number of these elements known in the art. In various embodiments, camera 104 and/or set-top box 102 may be integrated with television 106.

Social networking server 132, as described earlier, is associated with a social network. Social networking server 132 may include login functions 134, social networking functions 138, and networking interface 142. Login functions 134 may be configured to support traditional login methods. For the embodiments, login functions 134 may be further configured with face recognition function 136 to cooperate with FRBC 110, and enable face recognition login for social networking and video chat. Social networking functions 138 may be configured to support conventional social networking function, such as creation of social media, and/or interaction with social media. For the embodiments, social networking functions 138 may be further configured to include video chat function 140 to support video chat between users of the social network.

For the embodiments, social networking servers 132 may be associated with storage 150. Storage 150 may be configured to store user profile data 152 and user created social media 154. User profile data 152 may include basic information, such as, names, addresses, phone numbers, interests, pictures and so forth of the users. Storage 150, except for its usage in arrangement 100, may be any one of a number of persistent magnetic, optical, or solid state mass storage devices known in the art.

Other user devices 162, as described earlier, are associated with other users of the social network. Some of the other user devices 162 may comprise set-top boxes similarly constituted as set-top box 102. Except for these other user devices 162, and their use in arrangement 100, other user devices 162 may be any one of user devices known in the art, including, but are not limited to, desktops, laptops, tablets, smart phones, game consoles, and so forth.

Network 122 may include a number of wired and/or wireless, local or wide area, private and/or public networks, such as the Internet.

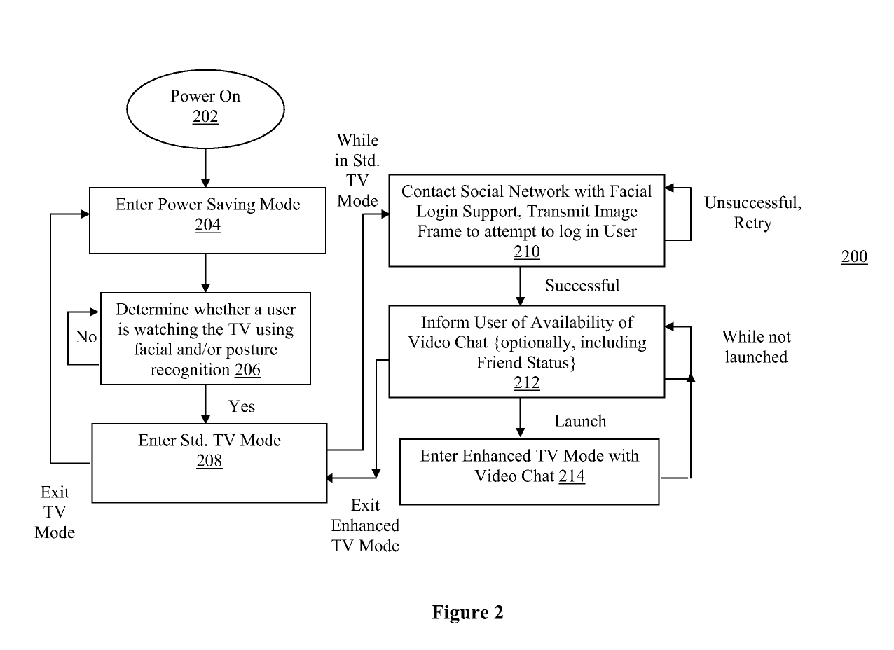

FIG. 2 illustrates a method suitable for use by the face recognition based controller of FIG. 1, in accordance with various embodiments of the present disclosure. As illustrated, for the embodiments, the method may begin at power on 202, where set-top box 102, camera 104 and television 106 may be powered on. From block 202, the method may proceed to block 204, where FRBC 110 may place television 106 in a power saving mode, consuming differentially less power than other operating modes, e.g., a television mode for viewing television programming, or an enhanced television mode for viewing television programming and accessing a social network. From block 204, the method may proceed to block 206, where FRBC 110 may determine whether a user is watching television 106. FRBC 110 may make the determination based on one or more image frames of a video signal provided by camera 104. FRBC 110 may make the determination, using one or more facial and/or posture recognition techniques known in the art.

On determination that no user is watching television 106, the method may remain on block 206, and repeat the determination periodically or on detection of changes in the one or more image frames. The frequency or periodicity of re-determination may be application dependent.

On determination that a user is watching television 106, the method may proceed to block 208, where FRBC 110 may place television 106 into a standard (std)/conventional television mode, where television programming may be rendered and watched by the user.

From block 208, the method may proceed to block 210, where FRBC 110 may contact the social network and attempt to log the user into the social network, if network access is available. In various embodiments, where the enrolled user data 112 include reference pictures of the users, their associated social networks, as well as their user identifiers and corresponding passwords, FRBC 110 may determine the user, including e.g., a user or face identifier, by matching the one or more image frames to the reference pictures. The matching may be performed using any one of a number of facial recognition techniques known in the art. In particular, for computational efficiency or other reasons, FRBC 110 may make the determination using facial recognition techniques that compare only corresponding facial regions of a selected subset of facial regions between the one or more image frames and the reference pictures. In various embodiments, on determining the user, FRBC 110 may further customize a user interface for television 106, adapting the user interface to a preferred arrangement of the user.

On identifying the user, FRBC 110 may transmit a login request to the social network. FRBC 110 may further transmit the user identifier and the password to the social network. The login request, user identifier and password may be transmitted together or successively, depending on the face recognition login protocol of the social network. The social network, in response, may authorize or deny the login based on the user identifier and the password.

In alternate embodiments, if supported by the social network, i.e. when login functions 134 includes face recognition login function 136, the login may be attempted using one or more of the image frames in lieu of the password. For these embodiments, on determining the user, FRBC 110 may transmit the user identifier and one or more of the image frames to the social network, in addition to or along with the login request. Face recognition login function 136, in response, may deny or authorize the requested login based on failure or success in matching the one or more image frames to the user's pictures within the social media contributed by the user, to confirm the user is the authorized user. Similarly, the matching may be performed using any one of a number of face recognition techniques known in the art. In particular, for computational efficiency or other reasons, face recognition login function 136 may make the determination using facial recognition techniques that compare only corresponding facial regions of a selected subset of facial regions between the one or more image frames and the user's pictures within the social media contributed by the user. For these embodiments, it may not be necessary to store the user passwords among enrolled user data 112.

In still other embodiments, if supported by the social network, i.e. when login functions 134 includes face recognition login function 136, the login may be attempted using one or more of the image frames in lieu of the password and the user identifier. For these embodiments, on determining the user, FRBC 110 may transmit the one or more of the image frames to the social network, in addition to or along with the login request. Face recognition login function 136, in response, may deny or authorize the requested login based on failure or success in matching the one or more image frames to a selection of pictures within the social media contributed by all users, to identify the user as an authorized user. Similarly, the matching may be performed using any one of a number of face recognition techniques known in the art. In particular, for computational efficiency or other reasons, recognition login function 136 may make the determination using facial recognition techniques that compare only corresponding facial regions of a selected subset of facial regions between the one or more image frames and the selection of pictures within the social media contributed by the user. For these embodiments, it may not be necessary to store the user identifiers and passwords among enrolled user data 112.

In various embodiments, if an attempt to log the user into a social network is unsuccessful, the method may remain in block 210, and repeat the attempt periodically, or on detection that network access is available again (if the attempt was unsuccessful because of network unavailability). Again, the frequency and periodicity of re-attempt may be application dependent.

From block 210, on successful logging the user into the social network, the method may proceed to block 212, where FRBC 110 may place the television in an enhanced television with social networking mode. While in block 212, FRBC 110 may receive social media from the social network. Further, FRBC 110 may receive status of various other users of the social network associated with the user, including e.g., whether these other associated users are available for video chat, what his/her mood looks like (smile, disgusted, angry etc.). FRBC 110 may render the status for the user, including e.g., an icon to launch video chat with one of these associated users available for video chat.

The method may remain at block 212 as long as the user continues to watch television without either launching video chat or logging off from the social network. From block 212, on launch of a video chat with one of the associated users, the method may enter block 214, where FRBC 110 may place television 106 in an enhanced television mode with social networking and video chat, and facilitates a video chat between the user and another associated user of the social network. The method may remain in block 214, until the user terminates the video chat or until FRBC 110 detects the user is no longer engaged in the video chat or a different user is engaged in the video chat. At such time, from block 214, the method may return to block 212, and continue from block 212.

At block 212, regardless whether a video chat was ever launched and/or performed, on logging off from the social network, or on detecting another user, in lieu of the logged in user, is watching the television or interacting with the social network, the method may return to block 208, where FRBC 110 may place the television in the standard/conventional television mode. In various embodiments, upon logging off from the social network, FRBC 110 may consult the user before re-attempting to log the user into the social network again.

From block 208, on command from the user to end television programming, or on detection that the user is no longer watching television, the method may return to block 204, where FRBC 110 may place television 106 in the power saving mode.

From block 204, the method may continue as earlier described.

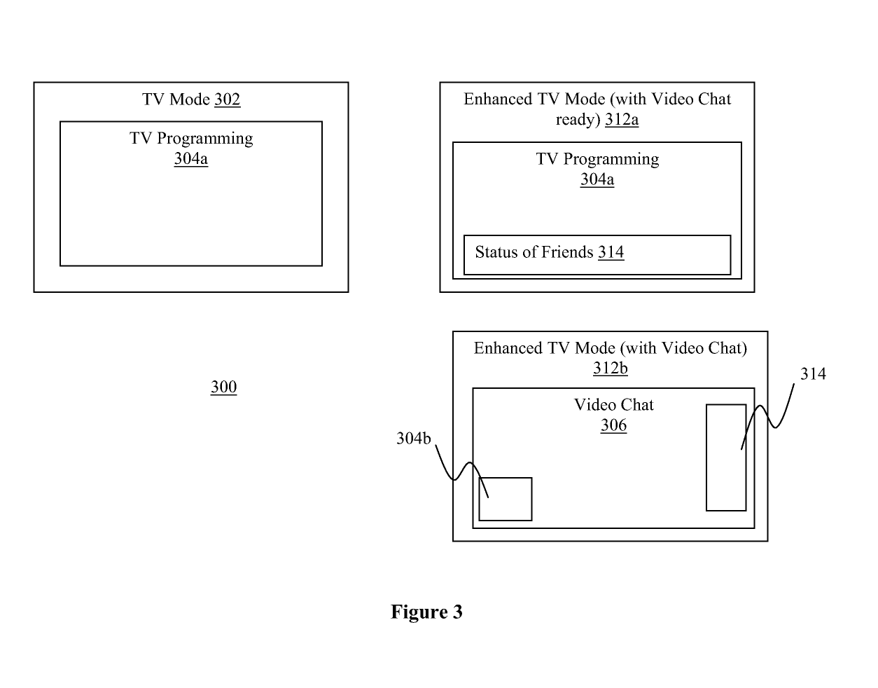

FIG. 3 illustrates a number instances of a user interface of the face recognition based control and social network arrangement of FIG. 1 in further details, in accordance with various embodiments of the present disclosure. As described earlier, while in standard/conventional TV mode 302, TV programming 304a may be rendered for the user. While in the enhanced television mode (without an active video chat), TV programming 304a may be rendered, along with video chat availability status 314 of the associated users (friends), for selection to launch a video chat with the selected associated user (friend). On launching of a video chat with a selected associated user (friend) or a number of users (friends), video chat 306 may be facilitated with status 314, and a reduced presentation 304b of the television programming.

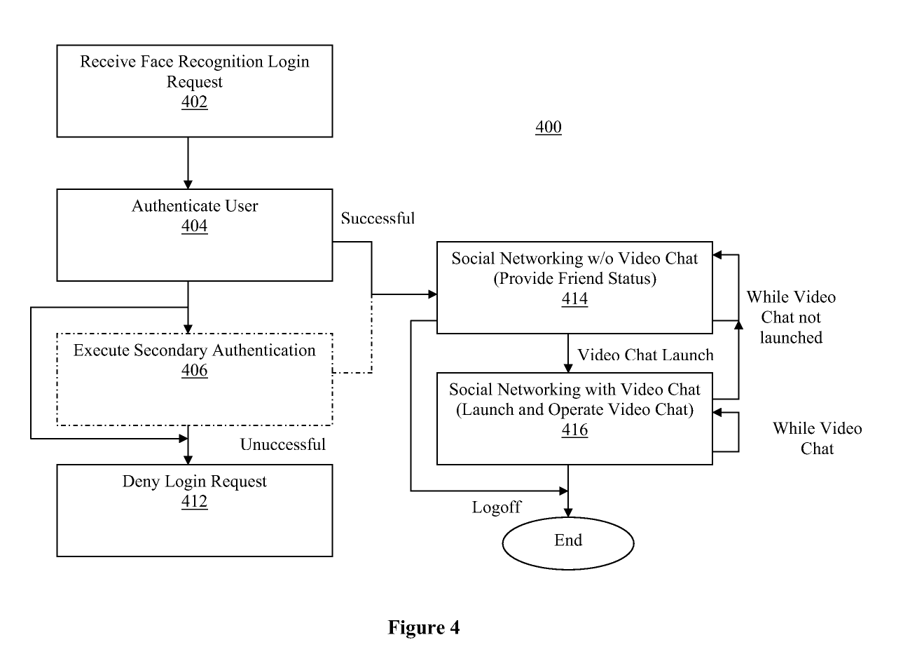

FIG. 4 illustrates a method suitable for use by the face recognition login function of FIG. 1, in accordance with various embodiments of the present disclosure. As illustrated, method 400 may start at block 402 where face recognition function 136 may receive a face recognition login request from a FRBC 110. As described before, face recognition login request may include one or more image frames of a user generated by camera 104, and optionally, a user identifier. From block 402, the method may proceed to block 404, where face recognition function 136 attempts to authenticate user, and deny or authorize the login, depending on whether the authentication is successful.

As described earlier, if a user identifier is provided, face recognition function 136 may attempt to authenticate the user by matching the one or more image frames to the user's pictures within the social media contributed by the user, to confirm the user's identity. If a user identifier is not provided, face recognition function 136 may attempt to authenticate the user by matching the one or more image frames to a selection of pictures within the social media contributed by all users to attempt to identify the user.

From block 404, the method may proceed to block 406, where face recognition function 136 may perform further authentication of the user. Face recognition function 136 may e.g., perform the further authentication if the confidence in identifying the user is below a desired threshold.

From block 404 or 406, on unsuccessful authentication, the method may proceed to block 412, where face recognition function 136 may deny the request to log the user into the social network. On successful authentication, the method may proceed to block 414, where face recognition function 136 may transfer control to social network functions 138 to provide conventional social networking features to the user, including e.g., the availability status of the user's associated users (friends) for video chat. The method may remain in block 414 as long as the user has not launched a video chat, logged off the social network or substituted by another user.

From block 414, on selection of an associated user and launching of a video chat, the method may proceed to block 416, where social network functions 138 may invoke video chat function 140 to facilitate the video chat between the user and the selected associated user(s), facilitating transmission and receipt of video chat data between the devices associated with the video chat users.

The method may remain at block 416, as long as the user is engaged in a video chat with another user of the social network. On termination of all video chats, the method may return to block 414, with video chat function 140 transferring control back to social networking functions 138, and continue as described earlier.

From either block 414 or 416, on logging off from the social network, the method may terminate with social networking functions 138, transferring control back to login functions 134, logging the user off the social network.

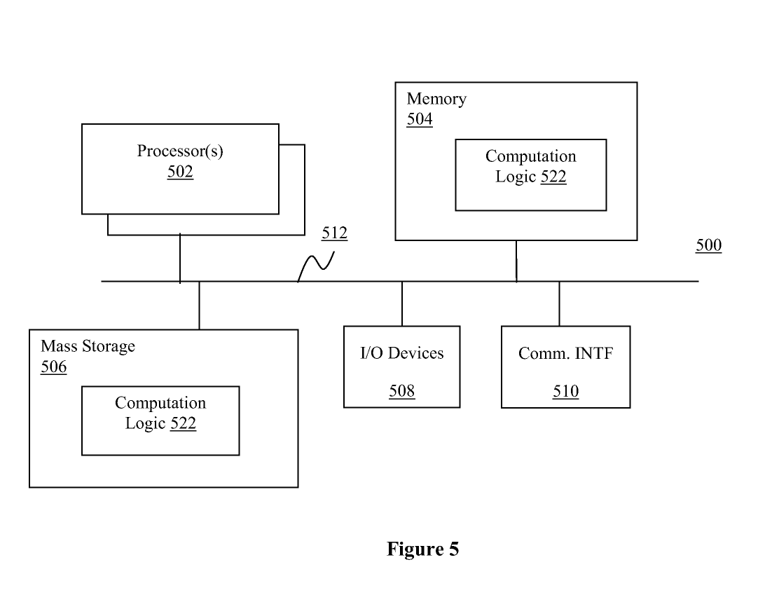

FIG. 5 illustrates an example computer system suitable for use to practice the set-top box or the social network server of FIG. 1, in accordance with various embodiments of the present disclosure. As shown, computing system 500 may include a number of processors or processor cores 502, and system memory 504. For the purpose of this application, including the claims, the terms “processor” and “processor cores” may be considered synonymous, unless the context clearly requires otherwise. Additionally, computing system 500 may include mass storage devices 506 (such as diskette, hard drive, compact disc read only memory (CDROM) and so forth), input/output devices 508 (such as display, keyboard, cursor control and so forth) and communication interfaces 510 (such as network interface cards, modems and so forth). The elements may be coupled to each other via system bus 512, which represents one or more buses. In the case of multiple buses, they may be bridged by one or more bus bridges (not shown).

Each of these elements performs its conventional functions known in the art. In particular, system memory 504 and mass storage 506 may be employed to store a working copy and a permanent copy of the programming instructions implementing the FRBC and related functions or the social networking functions with face recognition login, herein collectively denoted as computing logic 522. The various components, modules, or routines of the functions may be implemented by assembler instructions supported by processor(s) 502 or high-level languages, such as, for example, C, that can be compiled into such instructions.

The permanent copy of the programming instructions may be placed into permanent storage 506 in the factory, or in the field, through, for example, a distribution medium (not shown), such as a compact disc (CD), or through communication interface 510 (from a distribution server (not shown)). That is, one or more distribution media having an implementation of the agent program may be employed to distribute the agent and program various computing devices.

The constitution of these elements 502-512 are known, and accordingly will not be further described.

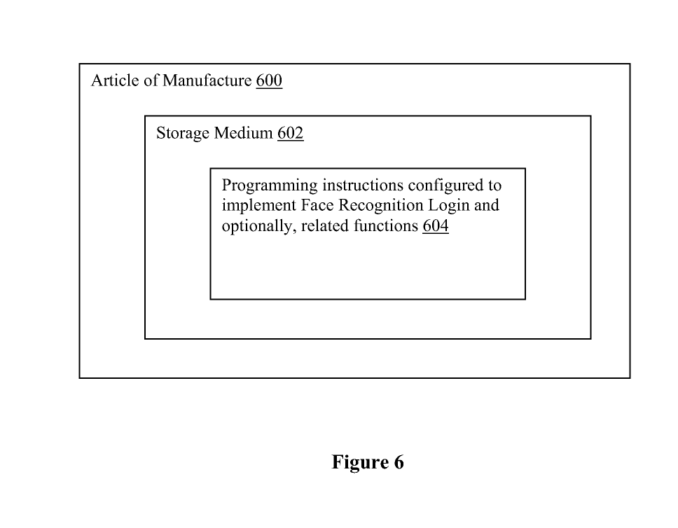

FIG. 6 illustrates an article of manufacture with programming instructions configured to enable an apparatus to practice the face recognition based control method and apparatus, in accordance with embodiments of the present disclosure. As shown, article of manufacture 600 may include computer-readable non-transitory storage medium 602. Storage medium 602 may include programming instructions 604 configured to implement the FRBC or the face recognition based login functions of FIG. 1.

Storage medium 602 represents a broad range of persistent storage medium known in the art, including but are not limited to flash memory, optical or magnetic disks. Programming instructions 604, in particular, may enable an apparatus, in response to their execution by the apparatus to perform operations including:
determining whether a user is watching a television based on one or more image frames of a video signal generated by a camera; and
transmitting a log in request, on determination that the user is watching the television, to a server associated with a social network, via a network interface of the apparatus, to log the user into the social network.

In alternate embodiments, programming instructions 604, in particular, may enable an apparatus, in response to their execution by the apparatus to perform operations including:
receiving one or more image frames, by a server associated with a social network, from an apparatus remotely disposed from the server, the apparatus being associated with or having a television; and
determining whether to allow a user to log into the social network, based at least in part on the one or more image frames.

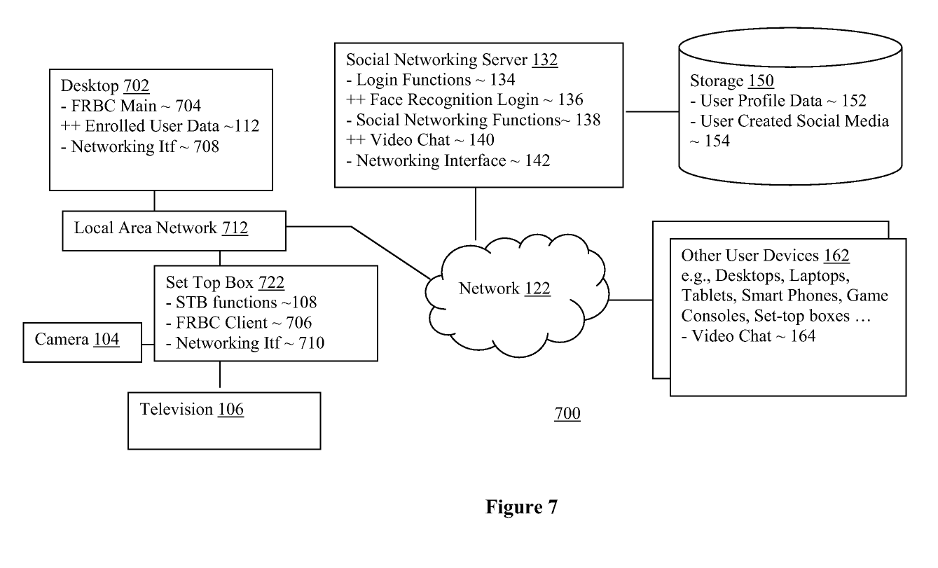

FIG. 7 illustrates an overview of another face recognition based control and social network arrangement, in accordance with various embodiments of the present disclosure. Arrangement 700 is substantially the same as arrangement 100 with the exception that FRBC 110 is implemented in two portions FRBC main 704 and FRBC client 706 respectively disposed on desktop 702, and set-top box 722. Collectively, FRBC main 704 and client 706 implement the functions earlier described for FRBC 110. Set-top box 722 and desktop 702 may also be respectively configured with networking interface 710 and 708, to couple with each other via local area network 712. Local area network 712 may be configured to provide access to earlier described network 122. Further, for the embodiments, enrolled user data 112 may be stored on desktop 702.

In this arrangement, user may use desktop 702 to log into social network from time to time, and set-top box 722 may enable the user to log into social network while watching television, without having to replicate the log in or other social media on set-top box 722.

In still other embodiments, desktop 702 may be remotely disposed from set-top box 722, and couple to set-top box 722 via network 122 instead.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present invention. This application is intended to cover any adaptations or variations of the embodiments discussed herein. Therefore, it is manifestly intended that the embodiments of the present invention be limited only by the claims and the equivalents thereof.

What is claimed is:

1. An apparatus, comprising:
a networking interface; and
a face recognition based controller coupled to the networking interface, and configured to determine whether a user is watching a television based on image frames of a video signal generated by a camera, and to transmit a log in request, via the network interface, to a server associated with a social network, on determination that the user is watching the television, to log the user into the social network.

2. The apparatus of claim 1, wherein the face recognition based controller is further configured to determine the social network, a user identifier of the user in the social network, and a user password for the user identifier, by matching the one or more image frames against a repository of user pictures, and to transmit the user identifier of the user, and the user password, to the server associated with the social network, on determination that the user is watching the television.

3. The apparatus of claim 2, further comprising the repository of user pictures.

4. The apparatus of claim 1, wherein the face recognition based controller is further configured to determine the social network, and a user identifier of the user in the social network, by matching the one or more image frames against a repository of user pictures, and to transmit the user identifier of the user, and one or more of the one or more image frames, to the server associated with the social network, on determination that the user is watching the television.

5. The apparatus of claim 1, wherein the face recognition based controller is further configured to transmit the one or more image frames, to the server associated with the social network, on determination that the user is watching the television.

6. The apparatus of claim 1, wherein the face recognition based controller is further configured to identify the user, using the one or more image frames, and to customize a user interface of the television, based on a result of the identification.

7. The apparatus of claim 1, wherein the face recognition based controller is further configured to transition the television between a power saving mode and a television mode, having different levels of power consumption, based on the determination on whether a user is watching the television.

8. The apparatus of claim 1 wherein the apparatus comprises a set-top box having the networking interface and the face recognition based controller.

9. The apparatus of claim 1 further comprising the camera, the television, or both.

10. A method comprising:
receiving one or more image frames, by a server associated with a social network, from an apparatus remotely disposed from the server, the apparatus being associated with or having a television; and
determining whether to allow a user to log into the social network, based at least in part on the one or more image frames.

11. The method of claim 10, wherein receiving further comprises receiving, by the server, a user identifier of the user, and determining comprises matching the one or more image frames against a plurality of social media of the social network contributed by the user.

12. The method of claim 10, wherein determining comprises identifying the user by matching the one or more image frames against a plurality of social media of the social network.

13. The method of claim 12, wherein receiving further comprises receiving, by the server, a fingerprint of the apparatus, and determining is further based on the received fingerprint of the apparatus.

14. The method of claim 12, wherein receiving further comprises receiving, by the server, a response to a challenge posed by the server, from the apparatus, and determining is further based on the received response to the challenge.

15. The method of claim 10, further comprising transmitting, by the server, a video chat launch icon for display on the television, and selection by the user, after logging the user into the social network.

16. The method of claim 15, further comprising transmitting, by the server, one or more status indicators of one or more other users associated with the user in the social network, for display on the television to indicate to the user, availability of the one or more other users for video chat with the user, after logging the user into the social network.

17. The method of claim 10, further comprising transmitting and receiving, to and from the television, by the server, audio and video signal associated with a video chat between the user and another user of the social network, after the user entering into a video chat with another user of the social network.

18. A computer-readable non-transitory storage medium, comprising
a plurality of programming instructions stored in the storage medium, and configured to cause an apparatus, in response to execution of the programming instructions by the apparatus, to:
determine whether a user is watching a television based on one or more image frames of a video signal generated by a camera; and
transmit a log in request, on determination that the user is watching the television, to a server associated with a social network, via a network interface of the apparatus, to log the user into the social network.

19. The storage medium, of claim 18, wherein the apparatus is further caused to determine the social network, a user identifier of the user in the social network, and a user password for the user identifier, by matching the one or more image frames against a repository of user pictures, and transmit the user identifier of the user, and the user password, to the server associated with the social network, on determination that the user is watching the television.

20. The storage medium, of claim 18, wherein the apparatus is further caused to determine the social network, and a user identifier of the user in the social network, by matching the one or more image frames against a repository of user pictures, and to transmit the user identifier of the user, and one or more of the one or more image frames, to the server associated with the social network, on determination that the user is watching the television.

21. The storage medium, of claim 18, wherein the apparatus is further caused to transmit the one or more image frames, to the server associated with the social network, on determination that the user is watching the television.

22. An apparatus comprising:
one or more processors;
a non-transitory storage medium coupled to the one or more processors, and having stored therein, a plurality of programming instructions, configured to cause the apparatus, in response to execution of the programming instructions, to
receive one or more image frames from a remotely disposed client device associated with or comprises a television; and
determine whether to allow a user to log into a social network associated with the apparatus, based at least in part on the one or more image frames.

23. The apparatus of claim 22, wherein to receive comprises to receive a user identifier of the user, and to determine comprises to match the one or more image frames against a plurality of social media of the social network contributed by the user.

24. The apparatus of claim 22, wherein to determine comprises to identify the user by matching the one or more image frames against a plurality of social media of the social network.

25. The apparatus of claim 22, wherein the apparatus, in response, is to further transmit, a video chat launch icon for display on the television, and selection by the user, after logging the user into the social network.

26. The apparatus of claim 25, wherein the apparatus, in response, is to further transmit one or more status indicators of one or more other users associated with the user in the social network, for display on the television to indicate to the user, availability of the one or more other users for video chat with the user, after logging the user into the social network.

27. The apparatus of claim 25, wherein the apparatus, in response, is to further transmit and receive, to and from the television, audio and video signal associated with a video chat between the user and another user of the social network, after the user entering into a video chat with another user of the social network.
